(19) United States
(12) Patent Application Publication
(10) Pub. No.: US 2005/0117599 A1
(43) Pub. Date: Jun. 2, 2005

(54) Network telephone system, main apparatus for the same system and connection information update method using the same system

(75) Inventor: Rumi Sugiyama, Isehara-shi (JP)

Correspondence Address: Finnegan, Henderson, Farabow,;Garrett & Dunner, L.L.P., 1300 I Street, N.W., Washington, DC, 20005-3315, US

(73) Assignee: KABUSHIKI KAISHA TOSHIBA

(21) Appl. No.: 10/986,083

(22) Filed: Nov. 12, 2004

(30) Foreign Application Priority Data
Nov. 28, 2003 (JP) 2003-400899

(51) Int. Cl. H04L 12/28

(52) U.S. Cl. 370/419

(57) ABSTRACT

A network telephone system connected via a communication network between a plurality of main apparatuses including at least one telephone terminal, at least one of the main apparatuses communicating with other main apparatus via the communication network, the main apparatuses each includes a memory which stores connection information for making a connection to the other main apparatus and identification information for receiving a connection from the other main apparatus, a connecter which connects to the other main apparatus via the communication network based on the connection information on the memory, when the identification information on the memory is updated, a transmitter which transmits the updated identification information as the connection information to the other main apparatus, and an update circuit to update storage contents of the corresponding connection information on the memory, when receiving updated connection information from the other main apparatus.

### CROSS-REFERENCE TO RELATED APPLICATIONS

This application is based upon and claims the benefit of priority from prior Japanese Patent Application No. 2003-400899, filed Nov. 28, 2003, the entire contents of which are incorporated herein by reference.

### BACKGROUND OF THE INVENTION

1. Field of the Invention

The present invention relates to a network telephone system such as Internet Protocol (IP) telephone system, which makes voice communications between telephone terminals via IP network. In addition, the present invention relates to a main apparatus for the foregoing network telephone system, and a connection information update method using the same system.

2. Description of the Related Art

In recent years, a network telephone system (IP telephone system) has come into wise use. According to the network telephone system, image and voice are bi-directionally received and transmitted as packet data in real time via packet network. In the IP telephone system, communications between extensions and sending/receiving of an outside call are made for each main apparatus connected to packet network. In addition, communications between extensions and sending/receiving of an outside call are made between main apparatuses via the packet network.

In the foregoing IP telephone system, an IP address of the main apparatus is previously registered for each main apparatus in order to make communications between extensions and sending/receiving of the outside call. When making communications, the sender main apparatus and the receiver main apparatus are connected via the packet network based on the registered IP address.

However, according to the IP telephone system, if there exist several roots from the sender main apparatus to the receiver main apparatus, IP addresses for these roots must be manually registered. As a result, setup and registration are very troublesome. Moreover, the setup and registration of each IP address of the main apparatus must be made once more from the beginning every when a change of numbering plan and a system change such as increase of the main apparatus are carried out. As a result, much time and labor are taken to the maintenance.

In order to solve the foregoing problem, the following system has been proposed (for example, JPN. PAT. APPLN. KOKAI Publication No. 2003-198724). According to the system, a server for collectively managing the IP address of each main apparatus is provided on the packet network. The sever queries the IP address with respect to each main apparatus every predetermined period, and if a change of the IP address is made, automatically updates the IP address.

However, the foregoing system has the problem described below. For example, if a fault occurs in the server, communications via packet network are not quite made until the fault is released. In addition, the packet network is occupied while the sever queries the IP address with respect to each main apparatus. This is a factor of giving an influence to voice packet transmission.

### BRIEF SUMMARY OF THE INVENTION

Therefore, an object of the present invention is to provide a network telephone system, which can simply IP address setup and registration resulting from a system change using packet network in a short time, and reduce load to the packet network. In addition, another object of the present invention is to provide a main apparatus for the network telephone system, and to a connection information update method using the same system.

According to an aspect of the present invention, there is provided a network telephone system connected via a communication network between a plurality of main apparatuses including at least one telephone terminal, at least one of the main apparatuses communicating with other main apparatus via the communication network, the main apparatuses each comprising: a memory which stores connection information and identification information, the connection information includes information for making a connection to the other main apparatus and the identification information includes information for receiving a connection from the other main apparatus; a connecter which connects to the other main apparatus via the communication network based on the connection information on the memory, when the identification information on the memory is updated; a transmitter which transmits the updated identification information as the connection information to the other main apparatus; and an update circuit to update storage contents of the corresponding connection information on the memory, when receiving updated connection information from the other main apparatus.

According to another aspect of the present invention, there is provided a main apparatus used for a network telephone system connected via a communication network between a plurality of main apparatuses including at least one telephone terminal, at least one of the main apparatuses communicating with other main apparatus via the communication network, comprising: a memory which stores connection information and identification information, the connection information includes information for making a connection to the other main apparatus and the identification information includes information for receiving a connection from the other main apparatus; a connecter which connects to the other main apparatus via the communication network based on the connection information on the memory, when the identification information on the memory is updated; a transmitter which transmits the updated identification information as the connection information; and an update circuit to update storage contents of the corresponding connection information on the memory, when receiving updated connection information from the other main apparatus.

According to yet another aspect of the present invention, there is provided a method using a network telephone system connected via a communication network between a plurality of main apparatuses including at least one telephone terminal, at least one of the main apparatuses communicating with other main apparatus via the communication network, comprising: storing connection information for making a connection to the other main apparatus and identification information for receiving a connection from the other main apparatus in a memory in each main apparatus; connecting the other main apparatus via the communication network based on the connection information on the memory, when the identification information on the memory is updated; transmitting updated self-identification information as the connection information; and updating storage content of the corresponding connection information on the memory, when updated connection information is received from the other main apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view showing the configuration of a network telephone system according to a first embodiment of the present invention;

FIG. 2 is a block diagram showing the functional configuration of a main apparatus in the first embodiment;

FIG. 3 is a view showing storage contents of a storage section shown in FIG. 2;

FIG. 4 is a view to explain the procedure of the transmitting/receiving operation when a connection is made between main apparatuses in the first embodiment;

FIG. 5 is a flowchart to explain the operation by a control section when the connection to another main apparatus is made in the first embodiment;

FIG. 6 is a flowchart to explain the operation by the control section when a changed IP address arrives from another main apparatus in the first embodiment;

FIG. 7 is a view to explain the procedure of the transmitting/receiving operation when connection is made between main apparatuses in a network telephone system according to a second embodiment of the present invention;

FIG. 8 is a block diagram to explain the operation of updating an IP address for each group in a network telephone system according to a third embodiment of the present invention; and

FIG. 9 is a view showing the storage content of a group management table.

### DETAILED DESCRIPTION OF THE INVENTION

Embodiments of the present invention will be described below with reference to the accompanying drawings.

### First Embodiment

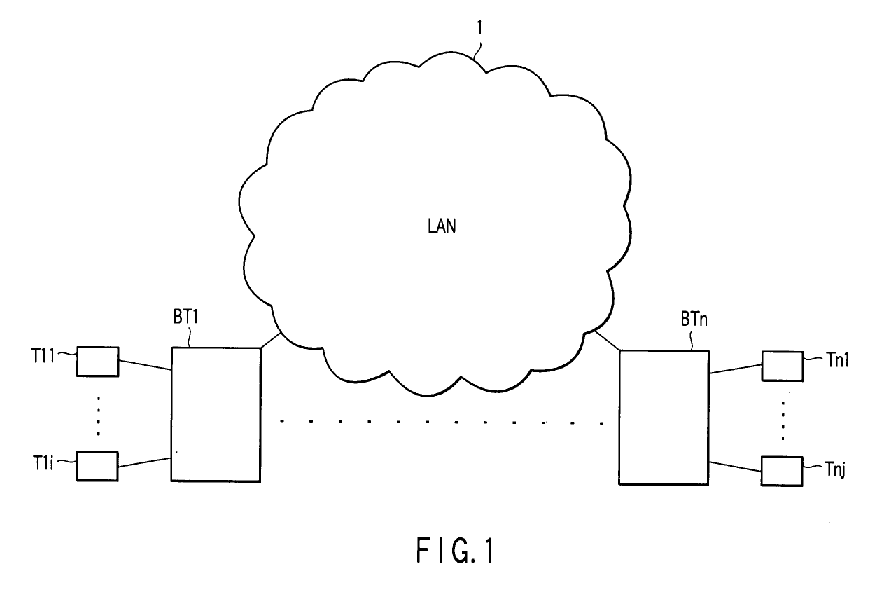

FIG. 1 is a schematic view showing the configuration of a network telephone system according to a first embodiment of the present invention.

The network telephone system has a Local Area Network (LAN) 1. The LAN 1 is connected with several main apparatuses BT1 to BTn (n is a natural number). The apparatuses BT1 to BTn are connected with telephone terminals T11 to T1i (i is a natural number) to Tn1 to Tnj (j is a natural number), respectively.

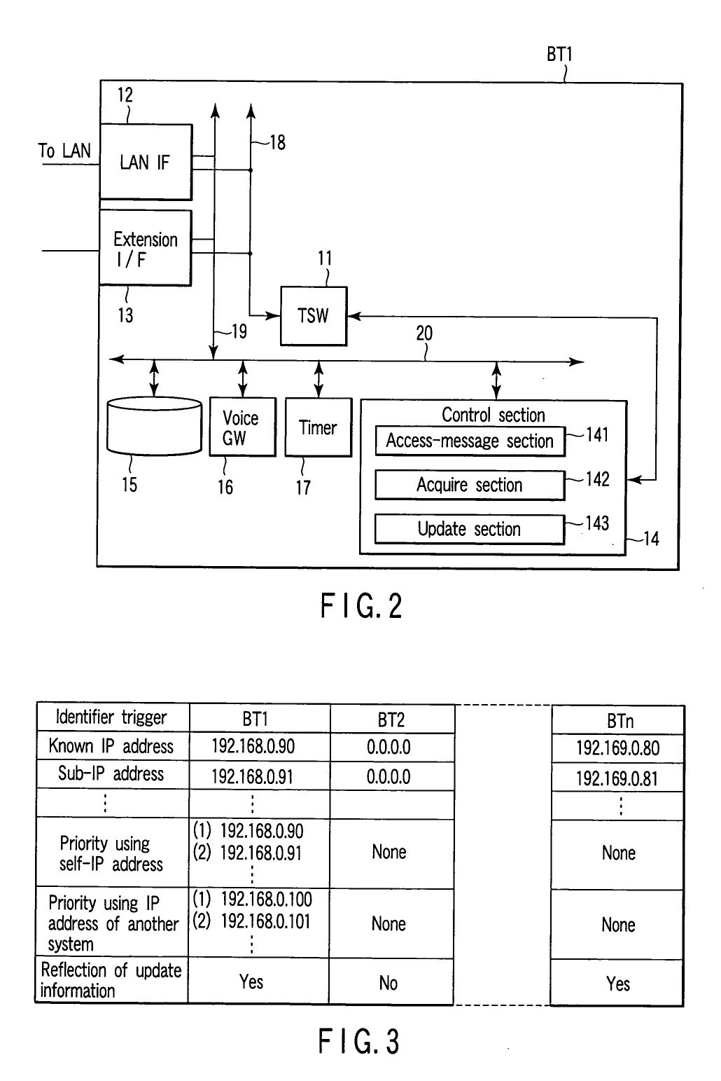

The apparatuses BT1 to BTn each have the following function according to the present invention. FIG. 2 is a block diagram showing the functional configuration. In this case, the main apparatus BT1 will be explained below as the typical example.

The main apparatus BT1 includes time switch (hereinafter, referred to as TSW) 11, LAN interface (LAN I/F) 12, extension interface (extension I/F) 13, control section 14, storage section 15, voice gateway (voice GW) 16 and timer 17. The foregoing TSW 11, LAN I/F 12, and extension I/F 13 are mutually connected via a PCM highway 18. In addition, the foregoing TSW 11, LAN I/F 12, and extension I/F 13 are mutually connected via a data highway 19.

The foregoing control section 14, storage section 15, voice GW 16 and timer 17 are connected via a CPU bus 20. Incidentally, the TSW 11 is connected directly to the control section 14.

The TSW 11 make a replacement of time slot on the PCM highway 18 based on the control by the control section 14, and thereby, arbitrarily makes an exchange between LAN IF 12 and extension IF 13.

The LAN IF 12 is connected with the LAN 1 as the need arises. The LAN IF 12 makes an interface operation relevant to the connected LAN 1. The following operations are given as the interface operation. One is to convert voice packet given via the LAN 1 into a PCM signal, and another is to convert a PCM signal given via the TSW 11 into voice packet. Another is to monitor the state of the LAN, and another is to transmit various signals to networks connected via LAN. The LAN IF 12 further makes an exchange of various control informations relevant the foregoing interface operation with the control section 14 via the data highway 19 and the CPU bus 20.

The extension IF 13 is connected with telephone terminals T11 to T1j as the need arises. The extension IF 13 makes an interface operation relevant to connected telephone terminals T11 to T1j. The extension IF 13 further makes an exchange of various control informations relevant the foregoing interface operation with the control section 14 via the data highway 19 and the CPU bus 20.

The control section 14 collectively controls the foregoing TSW 11, LAN I/F 12, and extension I/F 13 based on data stored in the storage section 15 to realize the operation as the main apparatus BT1.

The storage section 15 stores a table shown in FIG. 3 prepared correspondingly to the main apparatuses BT1 to BTn. The storage contents are known IP address, sub-IP address, priority of using self-IP address, priority of using IP address of another system, and information whether or not update information should be reflected.

The voice GW 16 makes connection and communication relevant to voice.

The timer 17 clocks current date and time.

The control section 14 of the first embodiment includes the following sections as a new function according to the present invention. One is a self-IP address access-message section 141 (hereinafter, referred to as access-message section 141). Another is an IP address acquire section 142 (hereinafter, referred to as acquire section 142). Another is a table update section 143 (hereinafter, referred to as update section 143).

If the self-IP address stored in the storage section 15 is added, changed or deleted, the access-message section 141 makes an access described below. The access-message section 141 makes access to other main apparatuses BT2 to BTn based on their each IP address via the LAN 1. Then, the access-message section 141 inserts the added, changed or deleted IP address into a control signal specified by QSIG protocol, for example, a facility information area determined by QSIG protocol, and thereafter, transmits it.

The acquire section 142 receives control signals sent from other main apparatuses BT2 to BTn via the LAN 1, and acquires each IP address inserted into the facility information area of the control signals.

When receiving the added, changed or deleted IP address from other main apparatuses BT2 to BTn, the update section 143 adds, changes or deletes the corresponding IP address in the table stored in the storage section 15.

The operation in the configuration described above will be explained below.

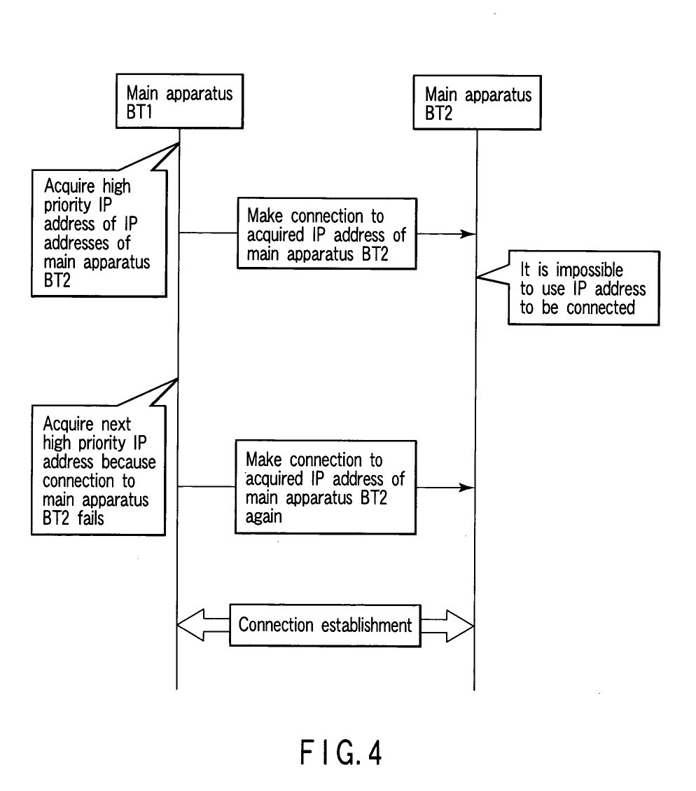

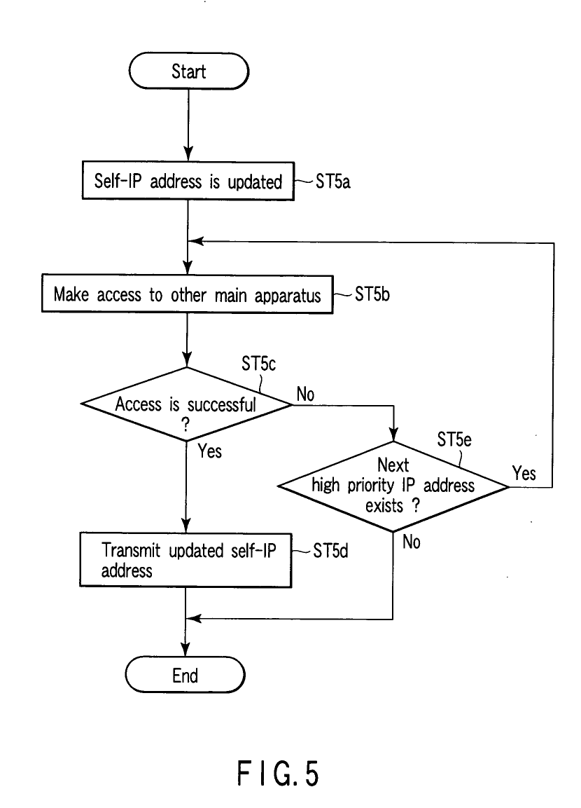

FIG. 4 is a view to explain the procedure of the transmitting/receiving operation when the connection from the main apparatus BT1 to the main apparatus BT2 is made. FIG. 5 is a flowchart to explain the operation by the control section 14 of the main apparatus BT1 when the connection to the main apparatus BT2 is made.

A self-IP address of the table stored in the storage section 15 is updated (step ST5a). In this case, the control section 14 of the main apparatus BT1 makes an access to the main apparatus BT2 using the highest priority IP address of the main apparatus BT2 (step ST5b). Thereafter, the control section 14 determines whether or not access is made within a preset time (step ST5c). If the access is made within the preset time (Yes), the control section 14 inserts an update message and the updated self-IP address into a facility information area of a control signal, and transmits them to the main apparatus BT2 (step ST5d).

On the other hand, the foregoing time elapses; nevertheless, if access is not made (No), the control section 14 determines whether or not the next priority IP address is stored in the storage section 15 (step ST5e). If the next priority IP address is stored in the storage section 15 (Yes), the control section 14 transfers to the step ST5b to again make the connection to the main apparatus BT2. Then, the control section 14 repeats the procedures of steps ST5b and ST5c until the connection to the main apparatus BT2 is made.

In step ST5e, if the next priority IP address is not stored in the storage section 15 (No), the control section stops the procedure, and thereafter, gives a message that no connection is made to the user of the main apparatus BT1.

Incidentally, the same procedure as described above is taken even if a new IP address is added or unnecessary IP address is deleted. The foregoing procedure is taken with respect to other main apparatuses BT3 to BTn at different timing.

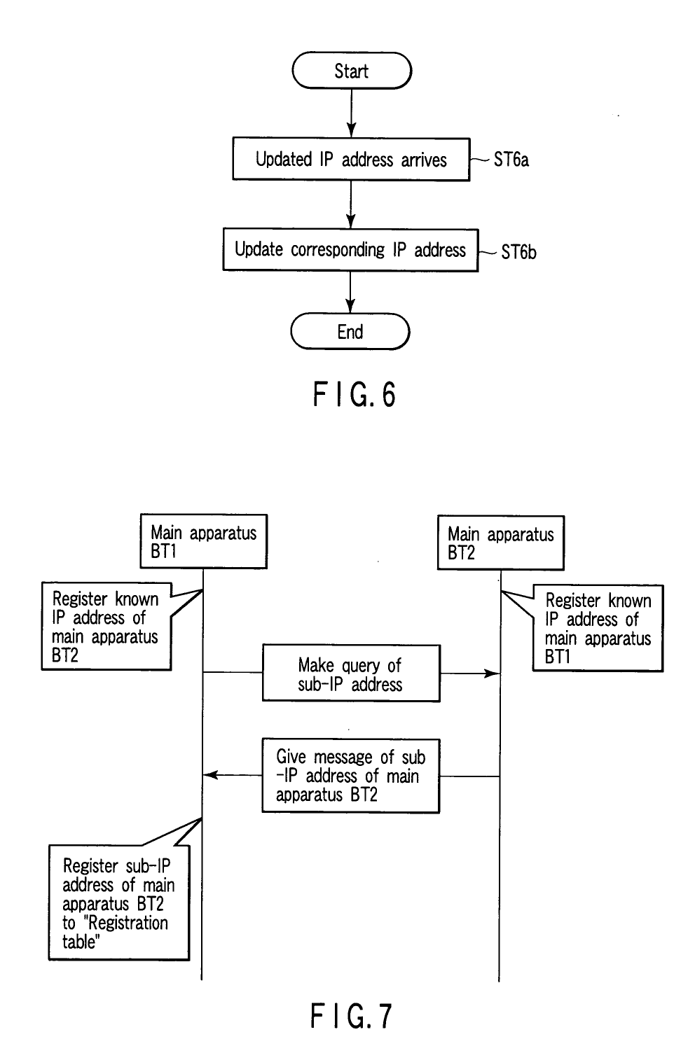

FIG. 6 is a flowchart to explain the operation by the control section 14 of the main apparatus BT1 when a changed IP address arrives from the main apparatus BT2.

An updated IP address and a control signal including a message that update is made arrive from the main apparatus BT2 (step ST6a). In this case, the control section 14 extracts the IP address inserted into the facility information area of the control signal and the message that update is made. Thereafter, the control section 14 updates the corresponding IP address in the table stored in the storage section 15 based on the given message (step ST6b).

Incidentally, the same procedure as described above is taken even if a newly added IP address or deleted IP address arrives. In addition, the same procedure is taken even if a message is given from other main apparatuses BT3 to BTn.

According to the first embodiment, the storage section 15 of the main apparatus BT1 previously registers the self-IP address and each IP address of other main apparatuses BT2 to BTn. If the self-IP address is added, updated or deleted, the BT1 transmits the added, updated or deleted self-IP address to other main apparatuses BT2 to BTn.

Therefore, every when each IP address of other main apparatuses BT2 to BTn is added, updated or deleted, the main apparatus BT1 timely acquires the IP address, and automatically registers it in the storage section 15. By doing so, it is possible to carry out IP address setup and registration resulting from a system change without spending much time and labor.

The user of the main apparatus BT1 only registers each IP address of other main apparatuses BT2 to BTn one time. Therefore, the operation required for the registration is largely simplified. In addition, there is no need of providing a server for collectively managing each IP address of main apparatuses BT1 to BTn. Therefore, this serves to reduce a load to the LAN 1; as a result, the cost reduction is achieved in the entirety of the system.

According to the first embodiment, when making the connection to other main apparatuses BT2 to BTn, the main apparatus BT1 selects and uses several IP addresses previously stored in the storage section 15 in the order of high priority. Therefore, even if the high priority IP address is used in another main apparatus BT3 or deleted, the main apparatus BT1 uses the next high priority IP address to make the connection. By doing so, even if the connection request concentrates on the main apparatus BT2 in the same time zone, relatively flexible measures against the concentration are taken.

According to the first embodiment, the main apparatus BT1 gives a message of the updated IP address to other main apparatuses BT2 to BTn using the facility information area of the already-existing control signal specified by QSIG protocol. Thus, there is no need of providing a dedicated signal line for giving a message of added, updated or deleted IP address. As a result, the configuration of the system is simplified.

### Second Embodiment

FIG. 7 is a view to explain the procedure of the transmitting/receiving operation when the connection from the main apparatus BT1 to the main apparatus BT2 is made in a network telephone system according to a second embodiment of the present invention.

For example, when the main apparatus BT1 boots, the control section 14 makes an access to the main apparatus BT2 based on the IP address stored in the storage section 14. Thereafter, the control section makes a query relevant to an added, updated or deleted IP address. In this case, the control section 14 inserts registered IP address and a query message into the facility information area of the control signal to be transmitted, and then, transmits them.

The main apparatus BT2 analyzes the IP address included in the facility information area of the received control signal and the message. If there exists IP address other than the foregoing IP address, the main apparatus BT2 gives a message that a new IP address exists to the main apparatus BT1.

Incidentally, the foregoing procedure may be taken according to the request from the user of the main apparatus BT1 in addition to the boot thereof.

Thus, according to the second embodiment, the following effect is obtained. For example, the changed IP address is not received after given from other main apparatuses BT2 to BTn in a time zone when the main apparatus BT1 does not boot. In this case, address query is made with respect to these apparatuses BT2 to BTn by the request of the user in the boot, and thereby, updated IP address is acquired.

### Third Embodiment

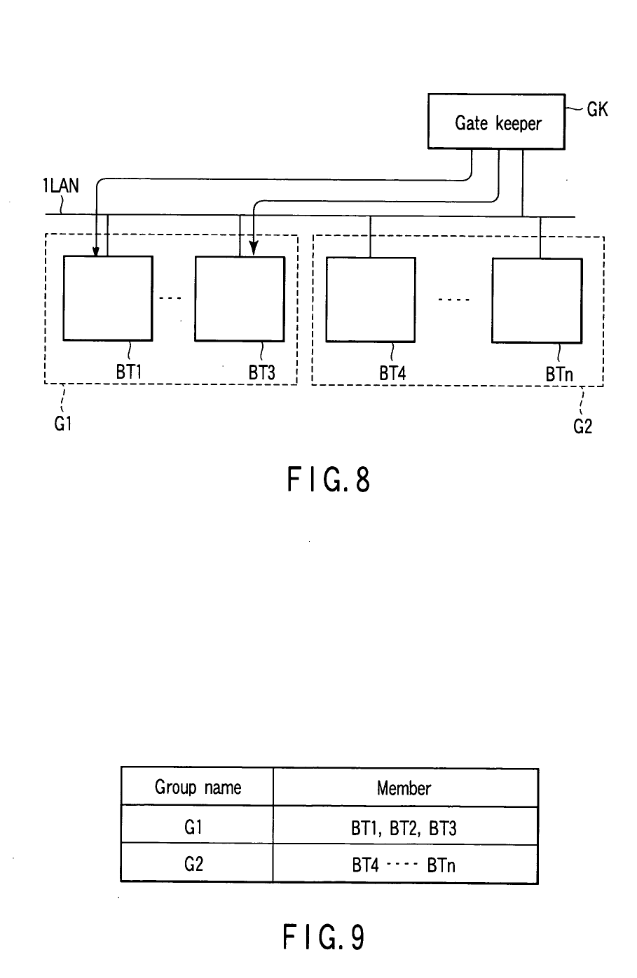

FIG. 8 is a block diagram to explain the operation of updating an IP address for each group in a network telephone system according to a third embodiment of the present invention.

The LAN 1 is further connected with a gatekeeper GK. The gatekeeper GK includes a group management table, and has a group allocation control function relevant to main apparatuses BT1 to BTn based on the group management table.

As seen from FIG. 9, the group management table stores data showing the corresponding relationship between several groups G1, G2 and some main apparatuses belonging to these groups G1, G2. In this case, the main apparatuses BT1 to BTn are divided into the groups G1 and G2.

The operation of the system having the foregoing configuration will be described below.

For example, the IP address is updated in the main apparatus BT1 shown in FIG. 8, and the updated IP address and a control signal including an update message are transmitted to the gatekeeper GK. The gatekeeper GK searches a group to which the main apparatus BT1 belongs from the group management table to detect main apparatuses BT2 and BT3 belonging to the identical group. Based on the detection result, the gatekeeper transmits the control signal to the main apparatuses BT2 and BT3 so that they update the IP address of the main apparatus BT1.

According to the third embodiment, the gatekeeper GK is provided with the group management table showing the corresponding relationship between main apparatuses BT1 to BTn and groups G1, G2. Thus, even if the update of IP address resulting from a system change is required, the update of IP address is concurrently controlled at the group unit.

For example, the number of the main apparatuses BT1 to BTn increases resulting from a system expansion, and the LAN 1 is used in common to many main apparatuses BT1 to BTn. Therefore, even if the environment described above is given, the update of IP address is concurrently controlled in the groups G1 and G2. As a result, it is possible to update the IP address in a relatively short time, and thus, to reduce a load to the LAN 1 resulting from the change of IP address. This serves to effectively use the LAN 1 in accordance with the system scale.

### Other Embodiments

The present invention is not limited to the foregoing embodiments. According to the first embodiment, if the updated IP address arrives from another main apparatus BT2, the corresponding IP address is automatically updated in the main apparatus BT1. The present invention is not limited to the first embodiment, and the following procedure may be taken if the updated IP address arrives from another main apparatus BT2. For example, a message that the IP address is updated is given to the user of the main apparatus BT1, and thereafter, the corresponding IP address is updated when the user inputs update instructions.

The update section 143 of the control section 14 may have two processing modes given below. One is a processing mode of automatically updating the corresponding IP address if updated IP address is received from another main apparatus. Another is a processing mode of automatically updating the corresponding IP address after the user inputs update instructions if updated IP address is received from another main apparatus. These modes may be selectively operated in accordance with the selection of the user. With the configuration, normally, the IP address is updated immediately every when the updated IP address is received. On the other hand, the IP address is updated in maintenance time only when the user determines that the update of the IP address is necessary. By doing so, the optimum update of IP address is carried out in accordance with various environments.

According to the third embodiment, the gatekeeper GK is provided with the group management table. However, if no gatekeeper GK is provided, at least one of the main apparatuses BT1 to BTn may be provided with the gatekeeper GK.

Besides, various changes may be made within a range without diverging from the subject matter of the present invention. More specifically, various changes are possible in the configuration and kind of the system and the main apparatus, kind of telephone terminal, and updated IP address message and update control procedures.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as specified by the appended claims and their equivalents.

1. A network telephone system connected via a communication network between a plurality of main apparatuses including at least one telephone terminal, at least one of the main apparatuses communicating with other main apparatus via the communication network,
the main apparatuses each comprising:
a memory which stores connection information and identification information, the connection information includes information for making a connection to the other main apparatus and the identification information includes information for receiving a connection from the other main apparatus;
a connecter which connects to the other main apparatus via the communication network based on the connection information on the memory, when the identification information on the memory is updated;
a transmitter which transmits the updated identification information as the connection information to the other main apparatus; and
an update circuit to update storage contents of the corresponding connection information on the memory, when receiving updated connection information from the other main apparatus.

2. The system according to claim 1, wherein the connecter connects to the other main apparatus via the communication network based on the connection information on the memory, when a new identification information is at least one of added information and deleted information on the memory, and
the update circuit executes at least one of addition and deletion of connection information on the memory, when receiving at least one of added connection information and deleted connection information from the other main apparatus.

3. The system according to claim 1, when several connection informations are allocated to the other main apparatus, wherein the memory stores the several connection informations in the memory together with connection priority, and
the connecter connects to the other main apparatus based on connection information showing the highest connection priority in the memory, and connects to the other main apparatus based on connection information showing the next connection priority in the memory, when no connection is made after a predetermined elapses.

4. The system according to claim 1, wherein the transmitter transmits the identification information on the memory as the connection information in accordance with a request from the other main apparatus.

5. The system according to claim 1, wherein the update circuit includes:
a first processing mode of voluntarily updating a storage content of the corresponding connection information on the memory when receiving updated connection information from the other main apparatus;
a second processing mode of given a message that the updated connection information it received from other main apparatus to a user, and updating the storage content of the corresponding connection information on the memory when the user inputs update instructions; and
a controller selectively carrying out the first and second processing modes in accordance with a mode designation operation.

6. The system according to claim 1, when a control signal transmitting via the communication network is specified by QSIG protocol, wherein the transmitter inserts the identification information into an information area determined by the QSIG protocol of the control signal, and transmits it, and
the update circuit updates the storage content of the corresponding connection information on the memory, when determining that connection information is inserted into a control signal received from other main apparatus.

7. The system according to claim 1, further comprising:
a storage circuit to store a table showing a corresponding relationship between several groups each composed of divided some main apparatuses and main apparatuses belonging to the groups,
wherein the transmitter determines group to which the self belongs by referring to the table, and transmits updated self-identification information as the connection information to all main apparatuses of the group, when the identification information on the memory is updated.

8. A main apparatus used for a network telephone system connected via a communication network between a plurality of main apparatuses including at least one telephone terminal, at least one of the main apparatuses communicating with other main apparatus via the communication network, comprising:
a memory which stores connection information and identification information, the connection information includes information for making a connection to the other main apparatus and the identification information includes information for receiving a connection from the other main apparatus;
a connecter which connects to the other main apparatus via the communication network based on the connection information on the memory, when the identification information on the memory is updated;
a transmitter which transmits the updated identification information as the connection information; and
an update circuit to update storage contents of the corresponding connection information on the memory, when receiving updated connection information from the other main apparatus.

9. The apparatus according to claim 8, wherein the connecter connects to the other main apparatus via the communication network based on the connection information on the memory, when a new identification information is at least one of added information and deleted information on the memory, and
the update circuit executes at least one of addition and deletion of connection information on the memory, when receiving at least one of added connection information and deleted connection information from the other main apparatus.

10. The apparatus according to claim 8, when several connection information are allocated to the other main apparatus, wherein the memory stores the several connection information in the memory together with connection priority, and
the connecter connects to the other main apparatus based on connection information showing the highest connection priority in the memory, and connects to the other main apparatus based on connection information showing the next connection priority in the memory, when no connection is made after a predetermined elapses.

11. The apparatus according to claim 8, wherein the transmitter transmits the identification information on the memory as the connection information in accordance with a request from the other main apparatus.

12. The apparatus according to claim 8, wherein the update circuit includes:
a first processing mode of voluntarily updating a storage content of the corresponding connection information on the memory when receiving updated connection information from the other main apparatus;
a second processing mode of given a message that the updated connection information it received from other main apparatus to a user, and updating the storage content of the corresponding connection information on the memory when the user inputs update instructions; and
a controller selectively carrying out the first and second processing modes in accordance with a mode designation operation.

13. The apparatus according to claim 8, when a control signal transmitting via the communication network is specified by QSIG protocol, wherein the transmitter inserts the identification information into an information area determined by the QSIG protocol of the control signal, and transmits it, and
the update circuit updates the storage content of the corresponding connection information on the memory, when determining that connection information is inserted into a control signal received from other main apparatus.

14. A method using a network telephone system connected via a communication network between a plurality of main apparatuses including at least one telephone terminal, at least one of the main apparatuses communicating with other main apparatus via the communication network, comprising:
storing connection information for making a connection to the other main apparatus and identification information for receiving a connection from the other main apparatus in a memory in each main apparatus;
connecting the other main apparatus via the communication network based on the connection information on the memory, when the identification information on the memory is updated;
transmitting updated self-identification information as the connection information; and
updating storage content of the corresponding connection information on the memory, when updated connection information is received from the other main apparatus.

15. The method according to claim 14, wherein the connecting includes connecting to the other main apparatus via the communication network based on the connection information on the memory, when a new identification information is at least one of added information and deleted information on the memory, and
the updating includes executing at least one of addition and deletion of connection information on the memory, when receiving at least one of added connection information and deleted connection information from the other main apparatus.

16. The method according to claim 14, when several connection information are allocated to the other main apparatus, wherein the storing includes storing the several connection information in the memory together with connection priority, and
the connecting includes connecting to the other main apparatus based on connection information showing the highest connection priority in the memory, and connecting to the other main apparatus based on connection information showing the next connection priority in the memory, when no connection is made after a predetermined elapses.

17. The method according to claim 14, wherein the transmitting includes transmitting the identification information on the memory as the connection information in accordance with a request from the other main apparatus.

18. The method according to claim 14, wherein the updating includes:
a first processing mode of voluntarily updating a storage content of the corresponding connection information on the memory when receiving updated connection information from the other main apparatus;
a second processing mode of given a message that the updated connection information it received from other main apparatus to a user, and updating the storage content of the corresponding connection information on the memory when the user inputs update instructions; and
controlling selectively carrying out the first and second processing modes in accordance with a mode designation operation.

19. The method according to claim 14, when a control signal transmitting via the communication network is specified by QSIG protocol, wherein the transmitting includes inserting the identification information into an information area determined by the QSIG protocol of the control signal, and transmitting it, and
the updating includes updating the storage content of the corresponding connection information on the memory, when determining that connection information is inserted into a control signal received from other main apparatus.

20. The method according to claim 14, further comprising:
storing a table showing a corresponding relationship between several groups each composed of divided some main apparatuses and main apparatuses belonging to the groups,
wherein the transmitting includes determining group to which the self belongs by referring to the table, and transmitting updated self-identification information as the connection information to all main apparatuses of the group, when the identification information on the memory is updated.
